(19) United States
(12) Patent Application Publication
(10) Pub. No.: US 2012/0119957 A1
(43) Pub. Date: May 17, 2012

(54) SHEET-SHAPED ANTENNA APPARATUS

(75) Inventor: Takashi ISHIDOSHIRO, Nagoya-shi (JP)

(73) Assignee: Buffalo Inc., Nagoya-shi (JP)

(21) Appl. No.: 13/278,577

(22) Filed: Oct. 21, 2011

(30) Foreign Application Priority Data
Oct. 22, 2010 (JP) P2010-237347

(51) Int. Cl. H01Q 1/24

(52) U.S. Cl. 343/702

(57) ABSTRACT

A sheet-shaped antenna apparatus includes an antenna element formed by pasting a conductive foil or coating a conductive paint, a power feeding line connected to the antenna element, a power generation unit connected to the power feeing line, and a bonding unit detachably bonded to a fixed surface to which the antenna apparatus is attached.

### CROSS REFERENCE TO RELATED APPLICATION

This application is based upon and claims the benefit of priority from the prior Japanese Patent Application No. 2010-237347 filed on Oct. 22, 2010; the entire content of which is incorporated herein by reference.

### BACKGROUND OF INVENTION

1. Field of Invention

The present invention relates to a sheet-shaped antenna apparatus, and more particularly, relates to a sheet-shaped antenna apparatus for an access point device.

2. Description of Related Art

Conventionally, various types of antenna apparatuses for an access point device of a radio communication system are provided. In recent years, there are antenna apparatus used indoors that are so designed that theirs appearance are not strongly appealed indoors in order to prevent an indoor atmosphere from being ruined (see, e.g. Japanese Unexamined Patent Application Publication No. 2004-140832, Japanese Unexamined Patent Application Publication No. 2006-319864) there is an antenna apparatus that is used by embedding it in an indoor inner wall.

### SUMMARY OF INVENTION

One antenna apparatus is so configured that it is embedded in the indoor wall and is connected to an access point device via a cable. It is possible to make the antenna apparatus itself not conspicuous because the antenna apparatus is embedded in the indoor wall. However, it is necessary to drill a hole on the indoor wall so that the access point device and the antenna apparatus are connected, it is complicated to perform an attachment work, and thus, it is not possible to easily change the installation location.

The other antenna apparatus is so configured that it is embedded in the indoor inner wall and is fed with power by an electromagnetic coupling with the access point device. This eliminates a need of drilling a hole on the inner wall in order to connect the access point device and the antenna apparatus. However, the antenna apparatus is embedded in the inner wall, and thus, it is not easy to attach and detach the antenna apparatus.

The present invention has been achieved in view of the above-described circumstances, and an illustrative object thereof is to provide a sheet-shaped antenna apparatus capable of being installed in an inconspicuous manner and easily changing an installation location.

According to one of the features of this invention, there is provided a sheet-shaped antenna apparatus including an antenna element formed by pasting a conductive foil or coating a conductive paint, a power feeding line connected to the antenna element, a power generation unit connected to the power feeing line, and a bonding unit detachably bonded to a fixed surface to which the antenna apparatus is attached.

According to the sheet-shaped antenna apparatus thus configured, it is possible to easily attach and detach to and from a fixed surface such as an indoor wall surface. Moreover, the antenna apparatus is equipped with a power generation unit, and thus, it is possible to operate independently of external feeding power. Therefore, there is no installation location limitation arising from a positional relationship with an external feeding device, and thus, it is possible to increase the freedom of the installation location.

It may suffice when the antenna element is configured by a conductive foil and conductive paint, for example, and the element can be configured by a slot line, a strip line, and a microstrip line, for example.

It may suffice when the power generation unit is structured thinly so that it can be attached to the sheet-shaped antenna apparatus, and, for example, it is possible to be configured by photovoltaic power generation that utilizes a solar cell to convert the energy of sunlight into power.

Moreover, the sheet-shaped antenna apparatus according to the present invention may includes a plurality of dipole antennas cascaded to one another, and is bonded to the fixed surface so that a connection direction of the antenna element is approximately parallel to a perpendicular direction.

According to the sheet-shaped antenna apparatus thus configured, it is possible to prevent radio waves from spreading in a perpendicular direction by increasing the directionality in an indoor horizontal direction. For example, in an apartment complex or an office building, antenna apparatuses may be individually installed on a plurality of floors. In this case, there is a need of increasing the directionality in a horizontal direction rather than the directionality in up-and-down direction lying across the floors.

Based on the sheet-shaped antenna apparatus according to the present invention, it is possible to exclusively increase the directionality in a horizontal direction while inhibiting radio waves from diffusing in up-and-down direction. Therefore, it is possible to inhibit radio wave leakage in upper and lower floors while increasing the directionality on a floor on which the sheet-shaped antenna apparatus is installed in an apartment complex or an office building, for example.

Moreover, the sheet-shaped antenna apparatus according to the present invention may include a radio wave absorber arranged between an antenna element and a power feeding line. According to the sheet-shaped antenna apparatus thus configured, it is possible to form a radio wave absorber near a center frequency of the antenna element.

The sheet-shaped antenna apparatus according to the present invention may further include a radio access point. It may suffice that the radio access point is arranged in the sheet-shaped antenna, and for example, the radio access point may be connected to a power feeding line or may be connected to a connection unit in a configuration where there is a connection unit configured to connect a power feeing line and a power generation unit.

Based on the sheet-shaped antenna apparatus according to the present invention, it is possible to install in an inconspicuous manner and easily change an installation location. Moreover, with a configuration where the antenna apparatus is formed by a cascaded dipole antenna, it is possible to inhibit a radio wave leakage in upper and lower floors while increasing the sensitivity of the radio waves.

### BRIEF DESCRIPTION OF DRAWINGS

FIG. 1 is an exploded view of a sheet-shaped antenna apparatus according to an embodiment.

FIG. 2A is a plan view of the sheet-shaped antenna apparatus according to the embodiment.

FIG. 2B is a rear view of the sheet-shaped antenna apparatus according to the embodiment.

### DESCRIPTION OF EMBODIMENTS

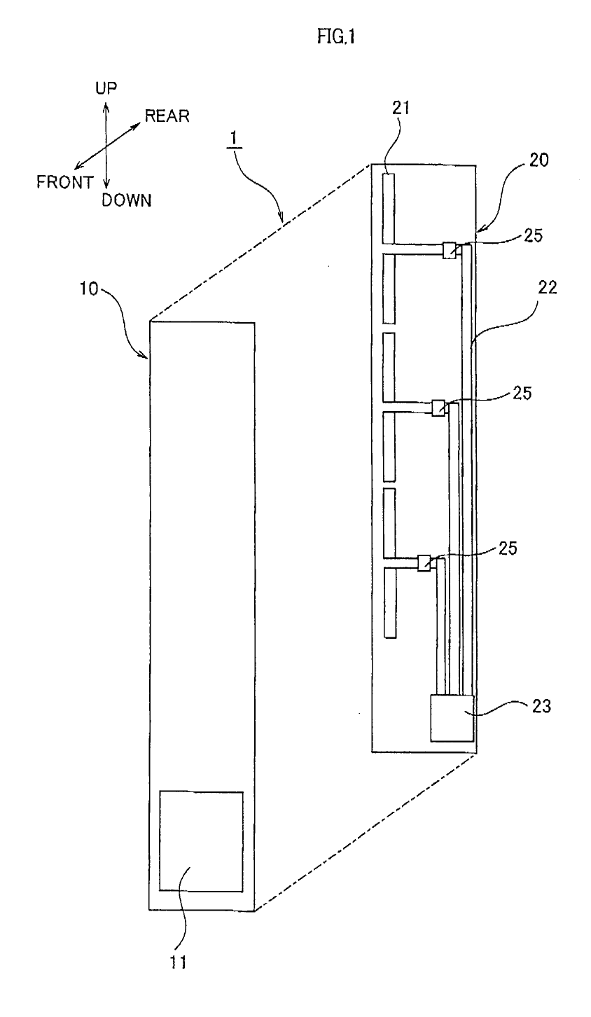

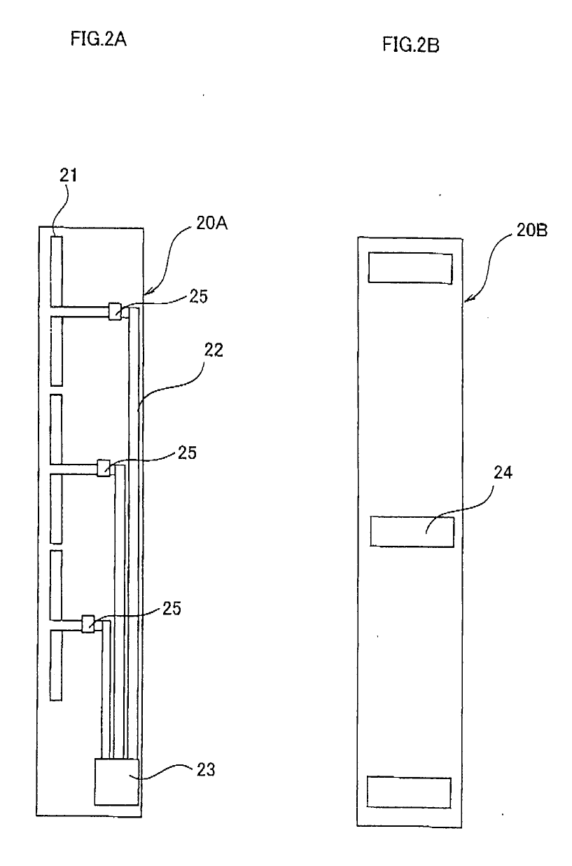

Next, a sheet-shaped antenna apparatus according to the present invention will be described in detail with reference to FIG. 1 and FIG. 2. FIG. 1 is an exploded view of the sheet-shaped antenna apparatus 1. FIG. 2A is a plan view of the sheet-shaped antenna apparatus according to the embodiment. FIG. 2B is a rear view of the sheet-shaped antenna apparatus according to the embodiment.

The sheet-shaped antenna apparatus 1 is an antenna apparatus for a radio access point device, and includes a substrate 20 to which an antenna element 21 is fixed and a cover layer 10 arranged at a surface side of the substrate 20. The cover layer 10 is arranged to cover the substrate 20, and is configured such that the substrate 20 cannot be visually confirmed from outside the sheet-shaped antenna apparatus 1.

As a result of providing the cover layer 10, the antenna element, etc., cannot be visually confirmed from outside, and thus, it is possible to design such that the sheet-shaped antenna apparatus 1 can be made inconspicuous. At the surface side of the cover layer 10, the photovoltaic power generation unit 11 is provided to be electrically connected to a connection unit 23 of the substrate 20.

On a surface 20A of the substrate 20, the antenna element 21 formed by a microstrip line, a power feeding line 22 formed by a microstrip line, and the connection unit 23 connected to the power feeding line 22 are provided. In other embodiments, it may be configured such that a radio access point is contained in the connection unit.

There is a radio wave absorber arranged between the antenna element and the power feeding line.

The microstrip line is a transmission path so structured that a linear conductive foil is formed on the surface of a plate-shaped dielectric substrate having a conductive foil being formed on the back surface. Radio waves are transmitted through this path. The antenna element 21 is a dipole antenna that is connected to the power feeding line 22 and that extends upwardly and downwardly in contrasting fashion. Three antenna elements 21 are cascaded. A connection direction of the antenna elements 21 is approximately equal to a longitudinal direction of the sheet-shaped antenna apparatus 1.

The sheet-shaped antenna apparatus 1, which includes a dipole antenna cascaded in a perpendicular direction, can sharpen the directionality in a horizontal direction such as an indoor horizontal direction, and thus, it is possible to prevent the radio waves from spreading in a perpendicular direction. In particular, it is possible to increase the directionality in a horizontal direction at an approximate center area of the cascaded dipole antennas. Therefore, it is possible to inhibit radio wave leakage in upper and lower floors while increasing the sensibility of the radio waves on a floor on which the sheet-shaped antenna apparatus is installed in an apartment complex or an office building, for example.

The sheet-shaped antenna apparatus 1 according to the present embodiment, which configures the antenna element 21 and the power feeding line 22 by a microstrip line formed by a conductive foil, can make the thickness of the sheet-shaped antenna apparatus 1 thinner as compared with a configuration in which the antenna element, etc., are formed by a conductive wire such as cable. Specifically, the sheet-shaped antenna apparatus 1 according to the present embodiment is 0.8 mm in thickness.

On a back surface 20B of the substrate 20, a bonding unit 24 bonded to the wall surface or fixed surface is provided. The bonding unit 24 is configured by adhesive that allows the sheet-shaped antenna apparatus 1 to be bonded and detached to and from the wall surface. Therefore, even after the sheet-shaped antenna apparatus 1 is attached to the wall surface, it is possible to detach it as necessary and attach it again at a different location. Therefore, it is possible to easily change the installation location of the sheet-shaped antenna apparatus. It is noted that in this embodiment, the bonding unit is configured by adhesive; however, the present invention is not limited thereto, and the bonding unit may be configured by an adhesive disk and clay, for example.

Thus, the preferred embodiment of the present invention is described; however, the present invention is not limited thereto, and a combination of features can be included. Further, it is possible to modify or change in various ways within the scope of the gist of the present invention.

For example, the sheet-shaped antenna apparatus according to the present embodiment includes the photovoltaic power generation unit configured to generate power by photovoltaic power generation; however, power generation means of the power generation unit is not limited to the photovoltaic power generation.

In the sheet-shaped antenna apparatus according to the present embodiment, the antenna element is arranged on the surface of the substrate and the cover layer covering the substrate is provided;

however, the antenna element may be arranged at the backside of the substrate without the cover layer, for example. Even in the sheet-shaped antenna apparatus thus configured, the sheet-shaped antenna apparatus can be attached in an inconspicuous manner.

In the sheet-shaped antenna apparatus according to the present embodiment, it may be configured that a terminal resistance circuit corresponding to an impedance of an antenna element is arranged at a power feeding point, radio waves passing through a transmission path are fetched, and electromagnetic absorption is formed. As a result of the provision of the electromagnetic absorber, it is possible to attenuate radio waves with a frequency higher than a center frequency band and radio waves with a frequency lower than a center frequency band in the antenna apparatus.

What is claimed is:

1. A sheet-shaped antenna apparatus, comprising:
an antenna element formed by pasting a conductive foil or coating a conductive paint;
a power feeding line connected to the antenna element;
a power generation unit connected to the power feeing line; and
a bonding unit detachably bonded to a fixed surface to which the antenna apparatus is attached.

2. The sheet-shaped antenna apparatus according to claim 1, wherein
the antenna element includes a plurality of dipole antennas cascaded to one another, and is bonded to the fixed surface so that a connection direction of the antenna element is approximately parallel to a perpendicular direction.

3. The sheet-shaped antenna apparatus according to claim 1 or claim 2, further comprising a radio wave absorber arranged between the antenna element and the power feeding line.

4. The sheet-shaped antenna apparatus according to claim 1 or claim 2, further comprising a radio access point.

5. The sheet-shaped antenna apparatus according to claim 3, further comprising a radio access point.
